(19) United States
(12) Patent Application Publication
(10) Pub. No.: US 2005/0009382 A1
(43) Pub. Date: Jan. 13, 2005

(54) Connector for connecting printed circuit boards

(75) Inventors: Michael Burmeister, Minden (DE); Jens Krause, Rahden (DE)

Correspondence Address: Norman P. Soloway;HAYES, SOLOWAY P.C., 130 W. Cushing Street, Tucson, AZ, 85701, US

(73) Assignee: HARTING Electro-Optics GmbH & Co. KG

(21) Appl. No.: 10/864,697

(22) Filed: Jun. 9, 2004

(30) Foreign Application Priority Data
Jul. 12, 2003 (DE) 20310734.9

(51) Int. Cl. H01R 12/00

(52) U.S. Cl. 439/67

(57) ABSTRACT

In order to produce an electric connection between at least two printed circuit boards, the invention proposes a connector with a mating side and a terminal side, in which an arrangement of several support members is provided in a housing. Spherical contacts for realizing the electric contacting of the strip conductors are arranged in said support members. At least one first support member is rigidly connected to a base circuit board with a terminal side while at least one second support member with a mating side is provided for inserting an edge-connector circuit board therein. The electric connection between the two support members is realized with strip conductors that are applied on a flexible conductive foil and contacted by the spherical contacts.

### TECHNICAL FIELD

The invention pertains to a connector with a mating side and a terminal side for connecting printed circuit boards.

### BACKGROUND OF THE INVENTION

A connector of this type is required for connecting printed circuit boards with a high signal line density and for high signal clock rates in a solder-free and separable fashion.

U.S. Pat. No. 4,157,857 discloses an edge-board connector for a printed circuit board that is fixed on a base circuit board, wherein spherical contact elements are arranged in a connector housing. The contact elements contact strip conductors on a plug-in printed circuit board on one side and strip conductors on the base circuit board on the other side via spring contacts that are connected in an electrically conductive fashion to a solderable terminal side.

### BRIEF SUMMARY OF THE INVENTION

In this edge-board connector, it is disadvantageous that the specifically predetermined geometry and number of contacting options invariably requires costly new developments in order to realize other edge-board connector variations.

Consequently, the invention is based on the objective of developing a connector of the initially described type in such a way that a large quantity of signal lines can be connected, wherein a spherical contact arrangement makes it possible to achieve an impedance-adapted signal transmission with minimal interference of the useful signals, and wherein scalable variations of the contacting arrangement can be realized with the least expenditure possible.

This objective is attained in that the terminal side is formed by at least one first support member that is mounted on the basic circuit board, in that the support member contains at least one spherical contact holder, in which spherical contacts are arranged adjacent to one another in at least one row, in that the mating side is formed by at least one second support member that contains a spherical contact holder, in which spherical contacts are arranged to both sides of an edge-connector circuit board to be inserted into the support member, and in that an electric connection between the first and the second support members is realized by means of strip conductors that are applied on a flexible conductive foil, wherein the spherical contacts are arranged in their holders such that they contact the strip conductors of the printed circuit boards on one side of the spherical contact holder and the strip conductors of the foil on the other side, and wherein the spheres are pressed against the strip conductors by means of spring elements.

Advantageous embodiments of the invention are disclosed in claims 2-8.

The advantages attained with the invention can be seen, in particular, in that the connector contains several spherical contact holders with several rows of spherical contacts that are arranged in at least one support member in order to transmit a higher signal line density. In this case, the support member as the supporting element for the relaxation-free transmission of the pressing forces for contacting the spheres may consist of an extruded metal profile, e.g., of aluminum or other materials or of a folded sheet metal. It is advantageous to mount a housing that is realized in the form of an angle connector on a base circuit board with its terminal side in a solder-free fashion, and to realize the mating side, for example, in the form of a receptacle for at least one edge-connector circuit board. The rigid mounting of the terminal side is realized, for example, by screwing the connector housing on the base circuit board such that a defective connector can be easily exchanged. However, it would also be possible to utilize a riveted connection, a snap-on connection or another connection for mounting the connector housing on the base circuit board. Depending on the respective embodiment, one or two support members for one or two edge-connector circuit boards may be provided on the mating side. The signal transmission between the contact rows in the contact carriers of a printed circuit board and another circuit board is realized by means of strip conductors applied on a flexible conductive foil. According to one preferred embodiment of the invention, the contact elements that are realized in the form of spheres can be displaced perpendicular to the strip conductor support surfaces and pressed against the strip conductors of the respective printed circuit boards with variable tolerance by means of spring elements. The spring elements are preferably realized in the form of flat, slightly V-shaped or W-shaped or U-shaped parts that are manufactured in the form of endless elements by means of a punching process, wherein the length of the spring elements can be adapted to the respective application. It is particularly advantageous to flexibly arrange the two support members for an edge-connector circuit board, wherein the support members are not arranged within a rigid connector housing, but rather such that they can be freely moved relative to one another and connected by means of a flexible foil, and wherein the support members may be arranged within the range of the foil independently of a certain modular dimension. In addition, the spherical contacts for an edge-connector circuit board are arranged in spherical contact holders that are advantageously divided into two parts on both sides of the printed circuit boards. This makes it possible for the spherical contact holders to carry out movements relative to one another and to adapt to the thickness of the printed circuit boards, namely without the individual spherical contacts having to travel excessively long distances. Fluctuations in the thickness of the printed circuit boards can be simultaneously compensated in this fashion. The utilization of the connector according to the invention also provides the advantage that the length of insertion of a connector can be adapted almost arbitrarily to the required size of the printed circuit board. In this case, the density of the signal lines can also be varied if the spacing between adjacently arranged spring elements is changed.

One embodiment of the invention is illustrated in the figures and described in greater detail below. The figures show:

### BRIEF DESCRIPTION OF THE DRAWINGS

FIG. 1, a sectional representation of the connector;

FIG. 2, a detailed section through a support member for a base circuit board;

FIG. 3, a detailed section through a support member for an edge-connector circuit board;

FIG. 4, a perspective representation of support members that are connected to one another;

FIG. 5, a perspective representation of the connector;

FIG. 6, a variation of the connector, and

FIG. 7, a schematic representation of the contacting achieved with the spherical contacts.

### DETAILED DESCRIPTION OF THE PREFERRED EMBODIMENT

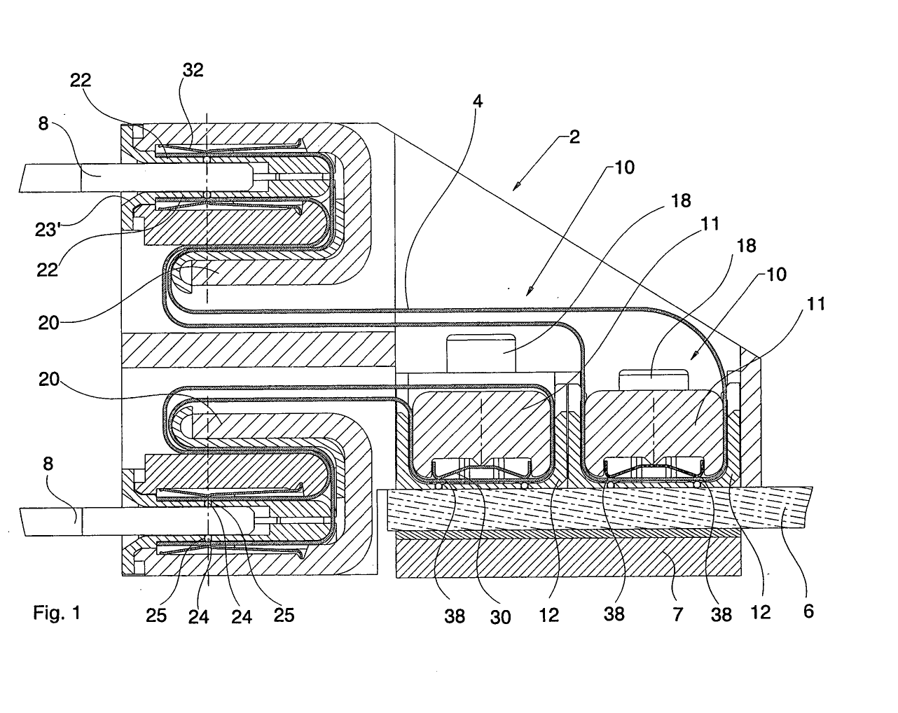

FIG. 1 shows a section through a connector for connecting printed circuit boards, in which a total of four individual support members are arranged a connector housing 2. In this case, two identical support members 10 that are arranged adjacent to one another and form the terminal side are fixed on a base circuit board 6, wherein two additional support members 20 that are also realized identically and form the mating side of the connector are arranged on top of one another and designed for respectively accommodating a plug-in edge-connector circuit board. The support members are respectively connected to one another within the connector housing by means of flexible conductive foils 4. The two support members 10 are arranged adjacent to one another and connected to the base circuit board 6 by means of a screw connection 18, wherein a transverse reinforcement 7—especially for large printed circuit boards—is provided underneath the base circuit board in order to additionally stabilize the support member and the base circuit board. This transverse reinforcement is connected with the same screw connection as the support member 10.

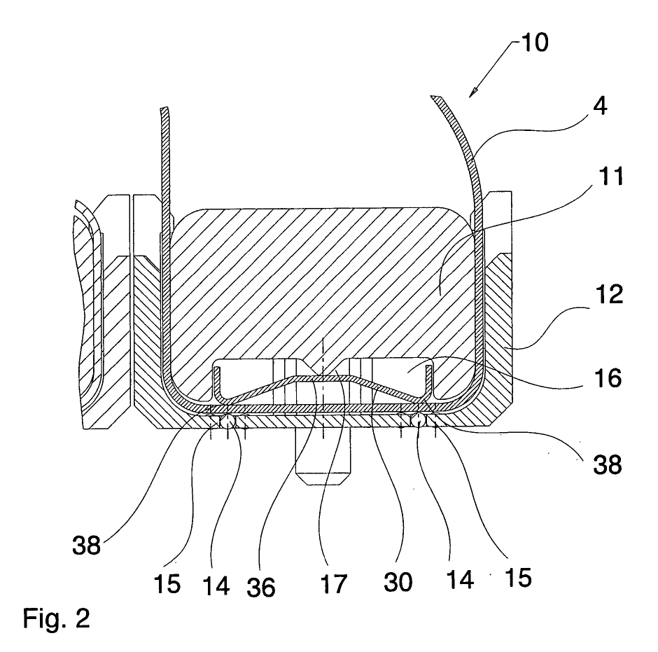

FIG. 2 shows an enlarged representation of a support member 10 for the base circuit board 6. The support member 10 essentially comprises a U-shaped spherical contact holder 12, in which a block-shaped pressing element 11 with a recess 16 for accommodating spring elements 30 is arranged. A flexible conductive foil 4 is inserted in a precisely fitted fashion between the U-shaped spherical contact holder 12 and the pressing element 11 in the form of a loop. Spherical contacts 14 are arranged in two rows in the base region of the spherical contact holder, namely in bores 15. These spherical contacts are pressed against not-shown strip conductors of the flexible conductive foil 4 by means of the spring elements 30. The spring elements 30 have the cross section of a W, wherein the ends of the outer limbs are pressed against the pressing element 11 in the recess 16 while the foil 4 is pressed against the spherical contacts 14 with the spring contact region 38. The flattened center section 36 of the spring is pressed against an integral projection 17 that centrally protrudes from the recess 16. The spring elements are punched out of a coherent, correspondingly shaped piece of sheet metal such that their length can be adapted to the respective connector housing or support member.

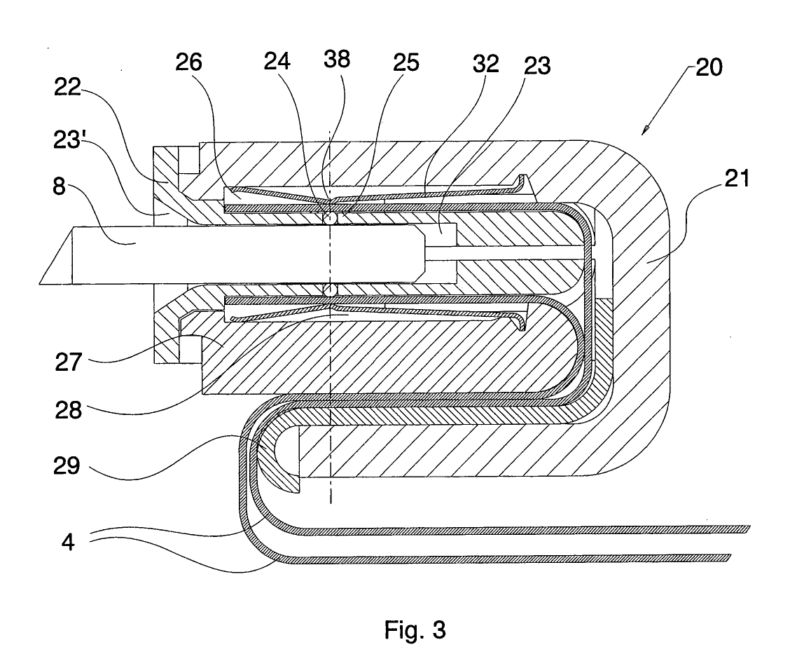

FIG. 3 shows an enlarged representation of the support member 20 that serves for inserting an edge-connector circuit board 8. The support member comprises a U-shaped support element 21, in which two contrarily shaped spherical contact holders 22, a pressing element 27, a moulded insulating part 29 and two flexible foils 4 in the form of loops are arranged. The two spherical contact holders 22 are spaced apart by an insertion slot 23 and provided with a bevel 23′ in order to simplify the insertion of the edge-connector circuit board 8. Spherical contacts 24 that are held in a captive fashion within the wall of the spherical contact holder 22 in bores 25 protrude into the insertion slot 23 from both sides in the region, in which the printed circuit board is inserted. This means that an inserted edge-connector circuit board 8 is contacted by the spherical contacts 24 on both sides and automatically centered in this fashion. The spherical contacts 24 for contacting the strip conductors on the flexible foil simultaneously protrude from the wall of the spherical contact holder 22 in the direction of the foil 4. The foil with the V-shaped spring element 32 consequently is pressed against the spherical contacts 24. For this purpose, a recess 26 is provided above the foil 4 in the upper limb of the support element 21, wherein the spring element 32 is arranged in this recess, and wherein one limb end penetrates into a depression in the limb while the other limb end is flattened and able to slide in the recess 26 depending on the contact pressure. An analogous recess is provided in the opposite limb of the support element 21 which forms the lower limb in this case, namely in the pressing element 27. The spring element 32 is also arranged in a recess 28. A moulded insulating part 29 is additionally provided between the lower limb of the support element 21 and the pressing element 27, wherein this insulating part ensures a precisely fitted retention of the flexible foil between the spring elements and the spherical contact holders and the pressing element, respectively. The moulded insulating part 29 is rounded on the side at which the foil emerges from the support element 21 in order to protect the two foils 4 from kinking.

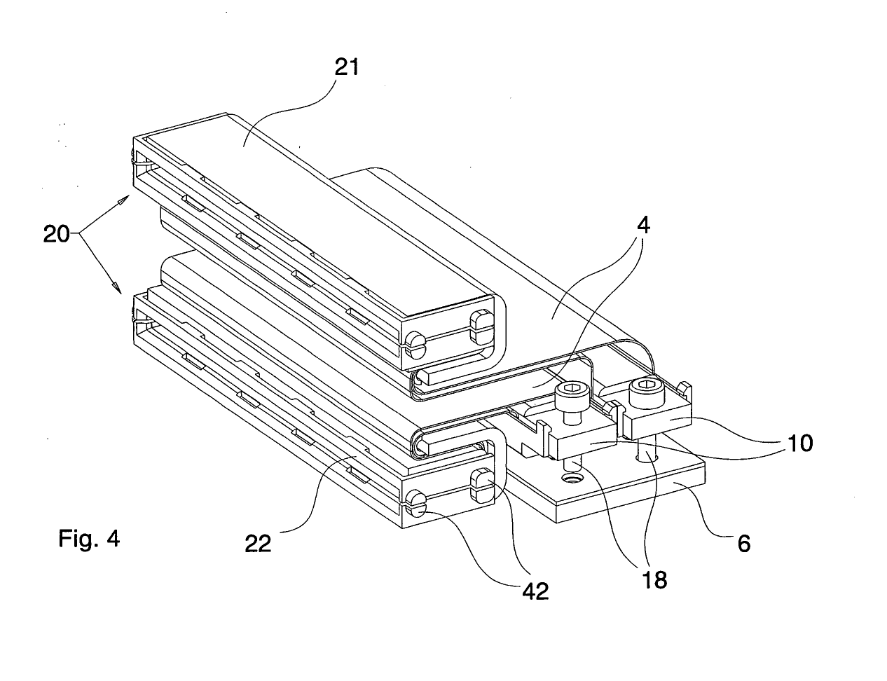

FIG. 4 shows a perspective representation according to FIG. 1 of the support members 10 and 20, namely without a rigid housing that surrounds the support members. In this case, the two support members 10 are mounted on the base circuit board 6 by means of a screw connection 18 while the support members 20 are arranged independently and only connected to the contact supports 10 by means of the flexible foil 4. Mounting pins 42 of different shapes are integrally formed onto the narrow sides of the support members 20, wherein the respective halves of said mounting pins are formed by the two spherical contact holders 22 arranged in the support element 21. The different shapes ensure a confusion-proof positioning within the housing 2, in which the corresponding recesses are provided. In such an embodiment without a common housing, the support members 20 can be arranged in a corresponding holder almost arbitrarily, i.e., in dependence on the length of the foil from the support members 10 and independently of a certain modular dimension that otherwise defines the spacing between two printed circuit boards.

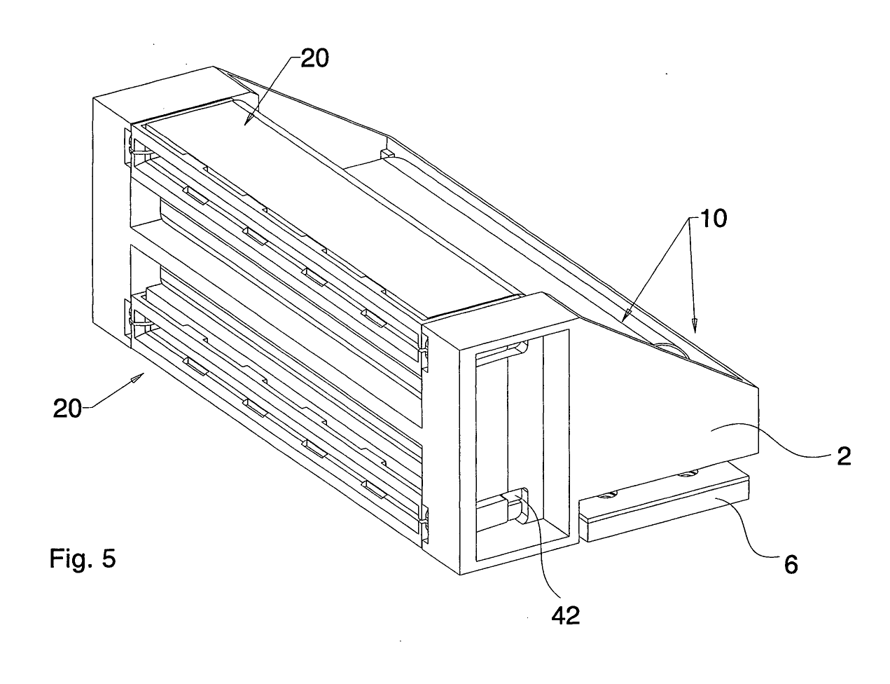

FIG. 5 shows the support member arrangement illustrated in FIG. 4 in the state in which it is inserted into the housing 2 fixed on the base circuit board 6. The housing essentially comprises of two lateral supports that are arranged parallel to one another and connected by means of a central connecting brace aligned perpendicular thereto. Openings are arranged in the lateral supports above and underneath the connecting brace, wherein the support members 20 can be inserted and snapped into said openings with lateral pins 42 that are integrally formed onto the support members. The support members 10 that are not visible in this figure are inserted into corresponding recesses in the housing in such a way that the entire housing can be fixed on the base circuit board 6 by means of the screw connections provided in the support members 10.

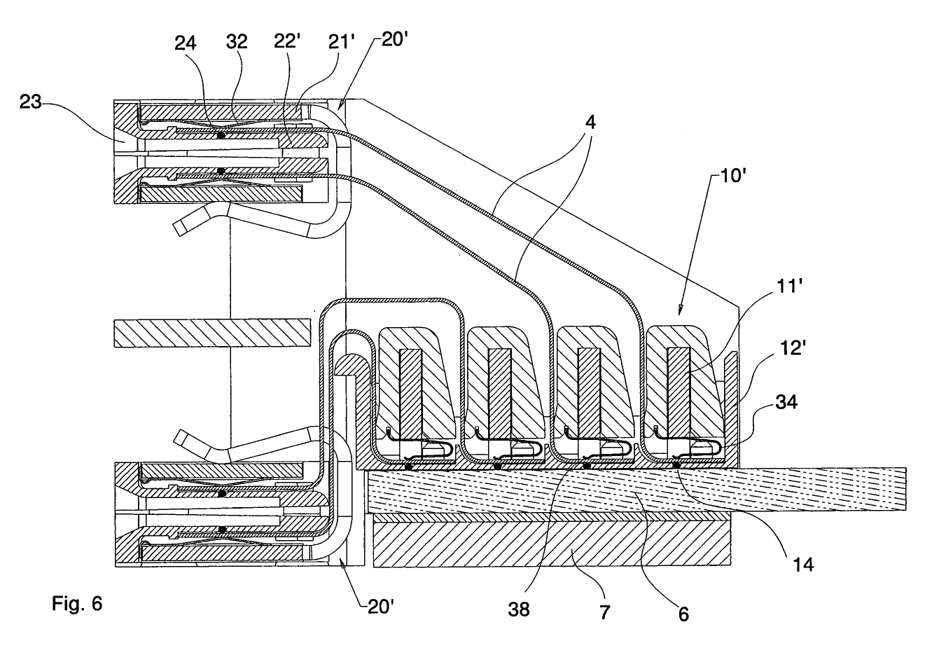

FIG. 6 shows one variation of the previously described connection with a housing 3 and flexible foils. This figure shows a support member 10′ with a spherical contact holder 12′, in which 4 identical pressing elements 11′ are arranged. One end of a flexible foil 4 is respectively inserted underneath the pressing elements and acted upon by a spring element 34 that is realized in a U-shaped fashion in this case. Four rows of adjacent spherical contacts 14′ are arranged underneath the foil in bores 15′ of the spherical contact holder 12′ such that the strip conductors applied on the base circuit board 6 are also contacted. The two support members 20′ are realized similar to those shown in FIG. 1, wherein the foils 4 are not arranged in the form of a loop, but rather extend directly into the contact region of the insertion slot 23′ in the support member from the opposite side of the mating side, i.e., from the rear side.

Flexible conductive foils with interconnected strip conductors applied on both sides are used in the described variations. However, the strip conductors are interrupted between the spring contact regions 38 of the spring 30 in the region in which the strip conductor in the support member 10 according to FIG. 1 is contacted by the spring element 30.

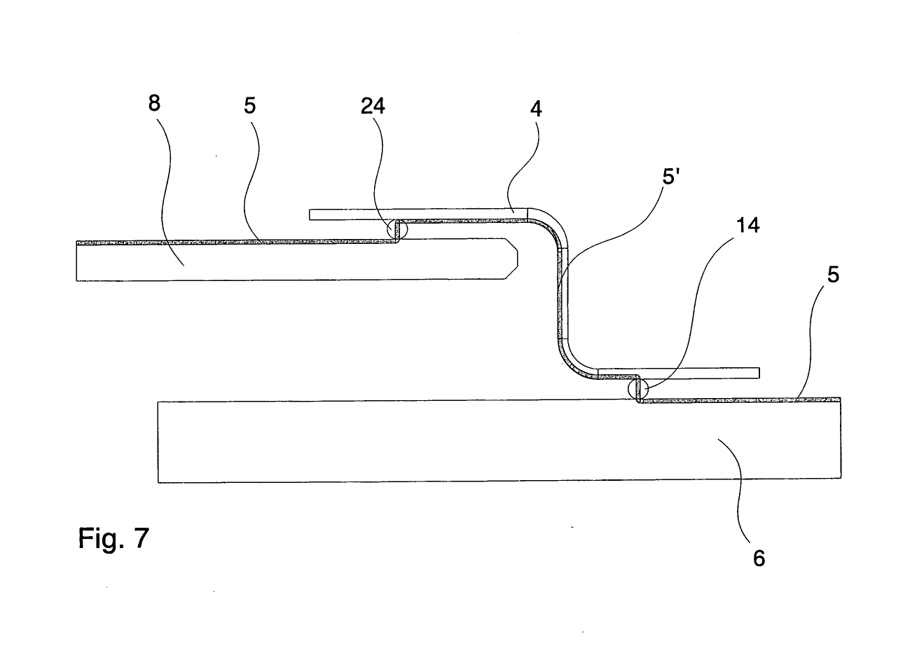

FIG. 7 shows the principle of the electric contacts produced between the strip conductors of the printed circuit boards and the flexible foils. In this case, the spherical contact 14 simultaneously contacts the strip conductor 5 of the base circuit board 6 and the strip conductor 5′ on the flexible foil 4. The signal line continues on the edge-connector circuit board 8 because the strip conductor 5′ is contacted with the strip conductor 5 on the edge-connector circuit board 8 by means of the spherical contact 24. However, only a one-sided contacting of the edge-connector circuit board is shown in this case.

1. A connector with a mating side and a terminal side for connecting and electrically contacting printed circuit boards, wherein the terminals side is formed by at least one first support member that is mounted on a base circuit board, wherein the support member contains at least one spherical contact holder, in which spherical contacts are arranged adjacent to one another in at least one row, wherein the mating side is formed by at least one second support member, wherein two spherical contact holders are arranged in one support element, and wherein spherical contacts are arranged in said holders to both sides of an edge-connector circuit board to be inserted into the support member, and wherein an electric connection between the first and the second support members is produced by strip conductors applied on a flexible conductive foil, wherein the spherical contacts are arranged in the spherical contact holders in such a way that they contact the strip conductors of the printed circuit boards on one side of the holder and the strip conductors of the foil on the other side, and wherein the spheres are pressed against the strip conductors by means of spring elements.

2. The connector according to claim 1, wherein the spherical contacts are held in the spherical contact holder that is provided with bores, wherein the bores are realized in such a way that the spheres cannot fall out at least on one side, but are able to contact the strip conductor.

3. The connector according to claim 1, wherein the spherical contact holders in the support member carry out a movement relative to one another, wherein the holders adapt to the thickness of the printed circuit board and compensate fluctuations in the thickness of the printed circuit board, and wherein the individual spherical contacts travel a minimal contacting distance.

4. The connector according to claim 1, wherein the individual spring elements are arranged adjacent to one another in the form of a coherent band, namely in recesses in pressing elements.

5. The connector according to claim 1, wherein the spherical contact holders and the support elements consist of an extruded metal profile or a folded sheet metal.

6. The connector according to claim 1, wherein the support member is inserted and held in the housing with means of polarization.

7. The connector according to claim 1, wherein the housing is mounted on the base circuit board by means of screw connections in the support member.

8. The connector according to claim 1, wherein the support members are held in separate housings.
